(19) United States
(12) Patent Application Publication
(10) Pub. No.: US 2020/0309337 A1
(43) Pub. Date: Oct. 1, 2020

(54) DAYLIGHTING DEVICE

(71) Applicant: SHARP KABUSHIKI KAISHA, Sakai City, Osaka (JP)

(72) Inventors: HIDEOMI YUI, Sakai City (JP); TSUYOSHI KAMADA, Sakai City (JP); SHUN UEKI, Sakai City (JP); DAISUKE SHINOZAKI, Sakai City (JP)

(73) Assignee: SHARP KABUSHIKI KAISHA, Sakai City, Osaka (JP)

(21) Appl. No.: 16/313,432

(22) PCT Filed: Jun. 30, 2017
(86) PCT No.: PCT/JP2017/024127

§ 371 Date: Dec. 26, 2018

(30) Foreign Application Priority Data
Jul. 1, 2016 (JP) 2016-131401

(51) Int. Cl. F21S 11/00; E06B 9/24; E06B 9/386; E06B 9/42; F21V 7/04; F21V 11/04; F21V 11/18

(52) U.S. Cl. CPC F21S 11/007; E06B 9/24; E06B 9/386; E06B 9/42; E04F 11/1853; F21S 11/002; F21V 11/04; F21V 11/18; E06B 2009/2417; F21V 7/04

(57) ABSTRACT

A daylighting device according to an aspect of the present invention is a daylighting device for a building construction including an eaves that blocks solar radiation on an outer side of a window. The daylighting device includes a daylighting member and a support member. The daylighting member includes a first base member that is light transmissive, a plurality of daylighting portions that are light transmissive and disposed on a first surface of the first base member, and a gap portion disposed between the plurality of daylighting portions. The support member supports the daylighting member. The daylighting device changes an orientation of light incident thereon and causes the light to emit to a space shaded by the eaves.

### TECHNICAL FIELD

An aspect of the present invention relates to a daylighting device.

The present application claims priority from Japanese Patent Application No. 2016-131401 filed Jul. 1, 2016, the content of which is herein incorporated by reference.

### BACKGROUND ART

Many buildings have an eaves on the outer side of a window. Such the eaves may block sunlight and prevent capture of full light into a room. Depending on factors such as the window's orientation or the altitude of the sun, solar radiation is blocked by the portion corresponding to the eaves, so that sunlight can be captured only during a limited duration.

To address this, for example, PTL 1 discloses a daylighting device including a light transmission diffuser panel, which transmits and diffuses sunlight, attached perpendicular to a bottom portion of an outdoor end of a cantilever balcony disposed at an upper floor of a building above the floor having an opening. Specifically, PTL 1 discloses a method for capturing a large amount of sunlight into a room with a daylighting device hanging at the edge of the eaves of the balcony.

### CITATION LIST

### Patent Literature

PTL 1: Japanese Patent No. 5684480

### SUMMARY OF INVENTION

### Technical Problem

The daylighting device in PTL 1 changes the direction of sunlight that is to fall in the space of a balcony or veranda so that the sunlight falls in the room. The amount of light captured in the space of the balcony or veranda thus remains unchanged. Moreover, compared to the case where the daylighting device is disposed at bare eaves (at the edge of eaves), the daylighting device has a problem of degrading the view from the room.

An aspect of the present invention is made in view of the problems of the existing technologies, and aims to provide a daylighting device capable of ensuring solar radiation to a space shaded by an eaves without degrading the view from a room.

### Solution to Problem

A daylighting device according to an aspect of the present invention is a daylighting device used for a building construction including an eaves that blocks solar radiation on the outer side of a window. The daylighting device includes a daylighting member and a support member that supports the daylighting member. The daylighting device includes a first base member that is light transmissive, multiple daylighting portions that are light transmissive and disposed on a first surface of the first base member, and gap portions disposed between the multiple daylighting portions. The daylighting device changes a direction of light incident thereon to emit the light to a space shaded by the eaves.

A daylighting device according to an aspect of the present invention may include a translucent protective member that covers, of a fine structure surface of the daylighting member and a back surface opposite to the fine structure surface, at least the fine structure surface, the plurality of multiple daylighting portions being disposed on the fine structure surface.

A daylighting device according to an aspect of the present invention may include a light-shielding member that blocks light incident on the daylighting member or a light-attenuating member that attenuates the light, the member being disposed on either one of a light incident side and a light emerging side of the daylighting member.

In a daylighting device according to an aspect of the present invention, the support member may be an attachment with which the daylighting member is attached to the building construction.

A daylighting device according to an aspect of the present invention may include a guide member that moves the daylighting member in one direction.

In a daylighting device according to an aspect of the present invention, the support member may be a support leg that allows the daylighting member to stand independently.

In a daylighting device according to an aspect of the present invention, the support member may include a rotation axis in a vertical direction.

In a daylighting device according to an aspect of the present invention, a plurality of the daylighting members may be coupled to each other using a coupling member.

A daylighting device according to an aspect of the present invention includes a plurality of slats and a support mechanism. The support mechanism couples the plurality of slats while having a longitudinal direction of the plurality of slats oriented in a horizontal direction, and supports the plurality of slats by allowing the slats to hang therefrom in a vertical direction. The daylighting member is employed as each of the slats.

A daylighting device according to an aspect of the present invention includes a daylighting screen; and a winding mechanism capable of winding the daylighting screen. The daylighting member is employed as the daylighting screen.

A daylighting device according to an aspect of the present invention includes a plurality of daylighting panels; and a panel frame that supports a pile of the plurality of daylighting panels. The daylighting member is employed as each of the daylighting panel.

### Advantageous Effects of Invention

According to an aspect of the present invention, a daylighting device capable of ensuring solar radiation to a space shaded by an eaves can be obtained.

### BRIEF DESCRIPTION OF DRAWINGS

FIG. 1 illustrates an installed state of a daylighting device according to a first embodiment.

FIG. 2 illustrates an installed state of the daylighting device according to the first embodiment.

FIG. 3 is a cross-sectional view of the structure of the daylighting device according to the first embodiment.

FIG. 4 illustrates a shaded area in a veranda on which a daylighting device is not placed.

FIG. 5 illustrates the state of solar radiation in a veranda on which the daylighting device according to the first embodiment is placed.

FIG. 6 illustrates the effect of the daylighting device according to the first embodiment.

FIG. 7 illustrates the daylighting state of the daylighting device integrated with a fence.

FIG. 8A is a first diagram illustrating a modification example of the daylighting device according to the first embodiment.

FIG. 8B is a second diagram illustrating a modification example of the daylighting device according to the first embodiment.

FIG. 8C is a third diagram illustrating a modification example of the daylighting device according to the first embodiment.

FIG. 8D is a fourth diagram illustrating a modification example of the daylighting device according to the first embodiment.

FIG. 9 is a perspective view of the entire structure of a daylighting device according to a second embodiment.

FIG. 10 is a cross-sectional view partially illustrating a related structure of the daylighting device according to the second embodiment.

FIG. 11 is a schematic structure of a daylighting device according to a third embodiment.

FIG. 12 illustrates the operation and effects (daylighting state) of the daylighting device according to the third embodiment.

FIG. 13 illustrates the operation and effects (light-shielding state) of the daylighting device according to the third embodiment.

FIG. 14 illustrates a modification example (roll-screen type) of the daylighting device according to the third embodiment.

FIG. 15 illustrates a modification example (bonded type) of the daylighting device according to the third embodiment.

FIG. 16A is a first diagram of an example of a light-attenuating member according to the third embodiment.

FIG. 16B is a second diagram of an example of the light-attenuating member according to the third embodiment.

FIG. 16C is a third diagram of an example of the light-attenuating member according to the third embodiment.

FIG. 17 illustrates a schematic structure of a daylighting device of Example 1 of a fourth embodiment.

FIG. 18 illustrates the operation and effects of the daylighting device of Example 1 of the fourth embodiment.

FIG. 19 illustrates the operation and effects of the daylighting device of Example 1 of the fourth embodiment.

FIG. 20 illustrates a schematic structure of a daylighting device of Example 2 of the fourth embodiment.

FIG. 21 illustrates a schematic structure of a daylighting device of Example 3 of the fourth embodiment.

FIG. 22 illustrates a schematic structure of a daylighting device of Example 1 of a fifth embodiment.

FIG. 23 illustrates a schematic structure of a daylighting device of Example 2 of the fifth embodiment.

FIG. 24 illustrates the operation and effects of daylighting devices of Examples 1 and 2.

FIG. 25 illustrates the installation state of a daylighting device according to a sixth embodiment.

FIG. 26A is a first diagram of the open and closed states of the daylighting device according to the sixth embodiment.

FIG. 26B is a second diagram of the open and closed states of the daylighting device according to the sixth embodiment.

FIG. 27A is a first diagram of a roll screen, serving as a modification example of the daylighting device according to the sixth embodiment.

FIG. 27B is a second diagram of a roll screen, serving as a modification example of the daylighting device according to the sixth embodiment.

FIG. 28A is a first diagram of a daylighting panel, serving as a modification example of the daylighting device according to the sixth embodiment.

FIG. 28B is a second diagram of a daylighting panel, serving as a modification example of the daylighting device according to the sixth embodiment.

FIG. 28C is a third diagram of a daylighting panel, serving as a modification example of the daylighting device according to the sixth embodiment.

FIG. 29 illustrates the operation and effects of the daylighting device according to the sixth embodiment.

### DESCRIPTION OF EMBODIMENTS

Hereinbelow, a daylighting device according to each embodiment of the present invention will be described.

Between the drawings described below, the dimensions of each component may vary for ease of illustration of the component.

A daylighting device according to each embodiment is used, for example, in a building construction having a space in which solar radiation is blocked by an eaves, such as a veranda, balcony, or terrace.

### First Embodiment

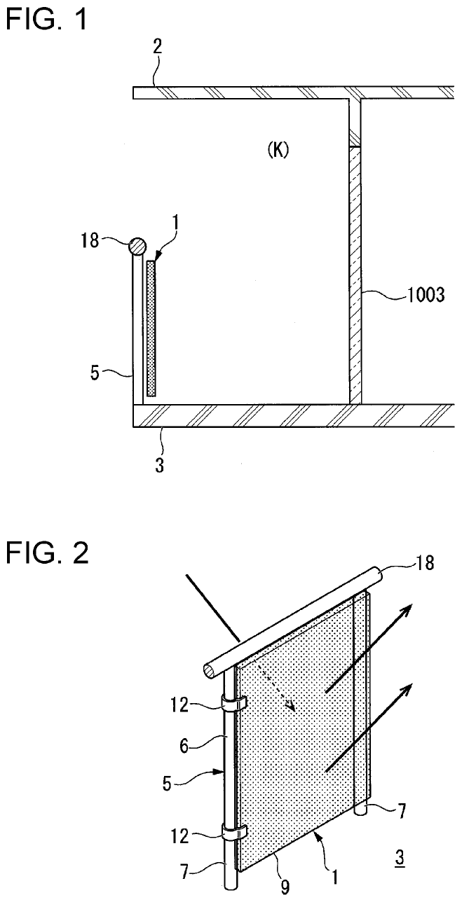

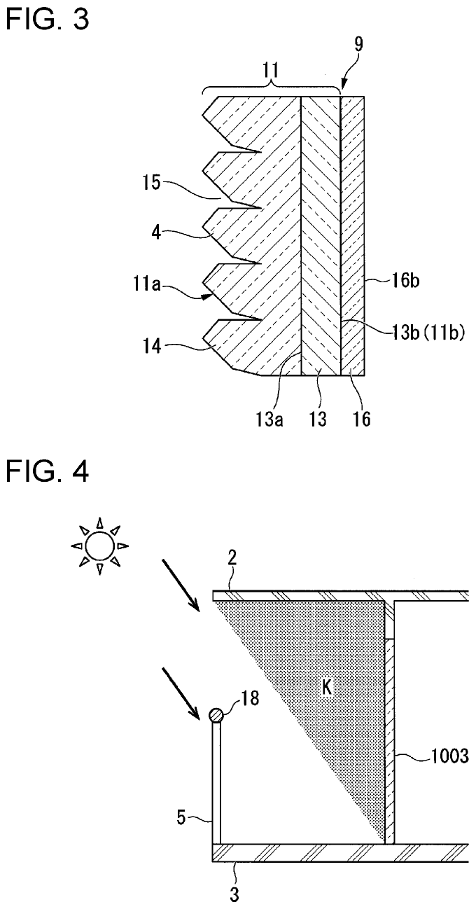

FIG. 1 illustrates an installed state of a daylighting device according to a first embodiment. FIG. 2 illustrates the installed state of the daylighting device according to the first embodiment. FIG. 3 is a cross-sectional view of the structure of the daylighting device according to the first embodiment.

As illustrated in FIG. 1, a daylighting device 1 according to the present embodiment is installed at, for example, a handrail portion 18 or a fence 5 of a veranda 3, irradiated with sunlight without being shaded by an eaves 2 of the veranda 3.

As illustrated in FIG. 2, the daylighting device 1 includes a daylighting structure 9 and multiple support members 12, which support the daylighting structure 9. The daylighting structure 9 is attached along the fence 5 (or may be the handrail portion 18) of the veranda 3 using these multiple support members 12. In the present embodiment, the daylighting device 1 can be attached to the outer side or inner side of the fence 5, but preferably, attached to the inner side of the fence 5 (inside the veranda 3) to be prevented from falling.

While the daylighting device 1 is installed at the fence 5, sunlight falls on the daylighting device 1 between multiple fence posts 7, constituting a vertical lattice 6.

As illustrated in FIG. 3, the daylighting structure 9 includes a daylighting member 11 and an anisotropic light diffusion film 16, which disperses light emerging from the daylighting member 11.

The daylighting member 11 includes a light transmissive daylighting film 14 and a light transmissive first base member 13.

The daylighting film 14 includes multiple daylighting portions 4, disposed on a first surface 13a of the first base member 13, and gap portions 15, disposed between the multiple daylighting portions 4.

Each of the multiple daylighting portions 4 is a translucent fine protruding structure on the order of several ten to several hundred micrometers. The daylighting portions 4 have a stripe shape, each extend in the horizontal direction, and are arranged in the vertical direction parallel to each other. The daylighting portions 4 have a polygonal cross section taken perpendicular to the longitudinal direction. The cross-sectional shape of the daylighting portions 4 is not limited to the one in the drawing, and may be appropriately changed in design in accordance with, for example, the purpose of the daylighting device 1. Specifically, the daylighting portions 4 may have a triangular cross section or a curved cross section taken perpendicular to the longitudinal direction as long as the daylighting portions 4 can exert the daylighting function.

The multiple daylighting portions 4 are formed from an optically transparent and photosensitive organic material, such as an acrylic resin, epoxy resin, or silicone resin. A mixture made of a transparent resin obtained by mixing a polymerization initiator, a coupler, a monomer, an organic solvent, or other objects into the above resin may be used.

In addition, the polymerization initiator may contain various types of additives such as a stabilizer, an inhibitor, a plasticizer, a fluorescent brightening agent, a release agent, a chain transfer agent, or other photo-polymerized monomer.

The total light transmittance of the daylighting portion 4 is, preferably, higher than or equal to 90% in accordance with JIS K7361-1.

Thus, the daylighting portion 4 can obtain sufficiently high transmittance.

Air is present in each gap portion 15 interposed between the adjacent daylighting portions 4. Thus, the index of refraction of the gap portion 15 is approximately 1.0. When the index of refraction of the gap portion 15 is assumed to be 1.0, the critical angle at the interface between the gap portion 15 and the daylighting portion 4 becomes minimum. When the index of refraction of the first base member 13 is largely different from the index of refraction of the daylighting portion 4, light that emerges from the daylighting portion 4 and is incident on the first base member 13 may be unnecessarily refracted or reflected at the interface between the daylighting portion 4 and the first base member 13. In this case, inconvenience such as a failure in obtaining intended daylighting characteristics or reduction of luminance may occur. Substantially equating the index of refraction of the daylighting portion 4 and the index of refraction of the first base member 13 enables obtaining intended daylighting characteristics to enhance the light use efficiency and reduce the glare.

Examples usable as the first base member 13 include optically transparent base materials such as resins including thermoplastic polymer, thermosetting resin, and photopolymerized resin. Examples of the optically transparent base materials include an acrylic polymer, an olefinic polymer, a vinyl polymer, a cellulosic polymer, an amide polymer, a fluorine polymer, a polyurethane polymer, a silicone polymer, and an imide polymer. Specifically, for example, optically transparent plate materials such as triacetylcellulose (TAC), polyethylene terephthalate (PET), a cycloolefin polymer (COP), polycarbonate (PC), polyethylenenaphthalate (PEN), polyether sulphone (PES), and polyimide (PI) are preferably used. Instead, the first base member 13 may be a glass base member. The first base member 13 may have any thickness. The first base member 13 may have a laminate structure formed by laminating multiple materials. The total light transmittance of the first base member 13 is preferably higher than or equal to 90% in accordance with JIS K7361-1. Thus, the first base member 13 can have sufficiently high transmittance.

Existing members such as ones having any structure that can fix the daylighting member 11 to the fence posts 7 are used as the support members 12. Examples include jigs that clamp the fence posts 7 and pipe mounting brackets.

The anisotropic light diffusion film 16 is disposed on a back surface 11b of the daylighting member 11 (a second surface 13b of the first base member 13), and has higher light diffusibility in the horizontal direction than in the vertical direction. Examples usable as the anisotropic light diffusion film 16 include a film having a structure including projections and depressions of the order of micrometers with a surface relief hologram pattern, such as a light diffusion control film (product name LSD) from Luminit.

In the present embodiment, the daylighting device 1 illustrated in FIG. 3 is installed while having a fine structure surface 11a of the daylighting member 11 including the multiple daylighting portions 4 oriented to the outer side of the veranda 3, and having the back surface 11b (the anisotropic light diffusion film 16) opposite to the fine structure surface 11a oriented to the inner side of the veranda 3 (toward a window 1003 illustrated in FIG. 1). However, the daylighting device 1 may be installed in other orientation. Conversely, the daylighting device 1 may be installed while having the fine structure surface 11a oriented to the inner side of the veranda 3 (toward the window 1003) and having the back surface 11b oriented to the outer side of the veranda 3.

FIG. 4 illustrates a shaded area in a veranda in which a daylighting device is not installed.

Buildings often include the eaves 2 on the outer side of the window 1003. The eaves 2 shades the veranda 3 or the interior or blocks sunlight that is to fall on the veranda 3 or the interior. The size (range) of a shaded space K varies with season of the year or time of day, and is not appropriately controllable.

The daylighting device 1 according to the present embodiment is attachable, in a building including the eaves 2, to the fence 5 or the handrail fully irradiated with sunlight without being shaded by the eaves 2. To ensure a bright environment in the shaded space K in the building including the eaves 2, the space K needs to be consciously irradiated with sunlight.

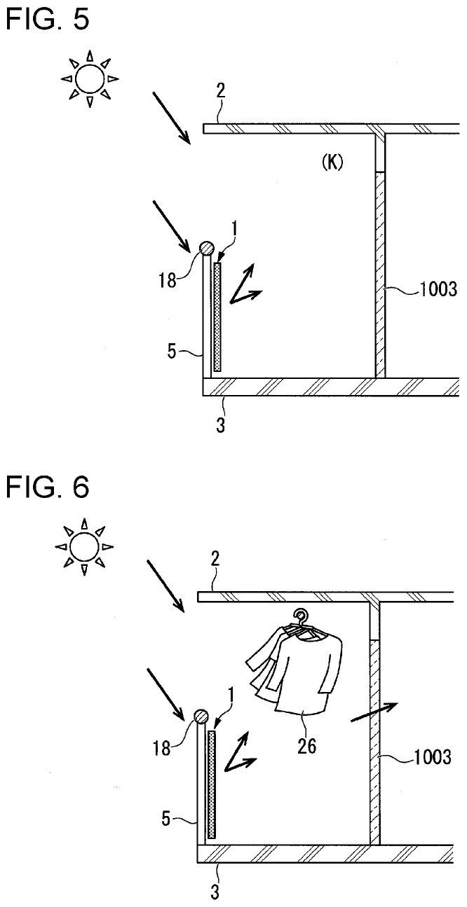

FIG. 5 illustrates the state of solar radiation of the veranda 3 in which the daylighting device 1 according to the first embodiment is installed.

As illustrated in FIG. 5, the daylighting device 1 according to the present embodiment is installed at the fence 5 of the veranda 3. Sunlight that is incident on the daylighting device 1 is refracted by the fine structure and emitted upward. The space K shaded by the eaves 2 is thus irradiated with light emerging from the daylighting device 1 to ensure a bright environment.

FIG. 6 illustrates an effect of the daylighting device 1 according to the first embodiment.

A clothes pole is often placed under the eaves 2 of the veranda 3. When the eaves 2 blocks sunlight, washing 26 may be hung in the shade even in the sun. However, the daylighting device 1 installed at the fence 5 of the veranda 3 can emit the sunlight toward the washing 26 to enable drying of the washing 26 in a short period, as in the case of sun drying.

Light that has passed through the daylighting device 1 installed at the fence 5 of the veranda 3 is emitted while having its direction changed toward approximately the ceiling of the veranda 3. The altitude and the orientation of the sun vary with season of the year and time of the day. Thus, the effect of the eaves 2 changes in accordance with the angle of incidence of light. The daylighting device 1 installed at the handrail or the fence 5, which is not affected by the eaves 2, ensures the space K, which has been shaded by the eaves 2, to be fully irradiated with sunlight for a longer time.

The daylighting device 1 installed at the handrail or the fence 5 also serves as a screen from the outside while maintaining the view from the room.

The daylighting device 1 (daylighting member 11) has a function of changing the angle of light with an optical phenomenon such as reflection, refraction, diffusion, or diffraction, and is not limited to the above structure.

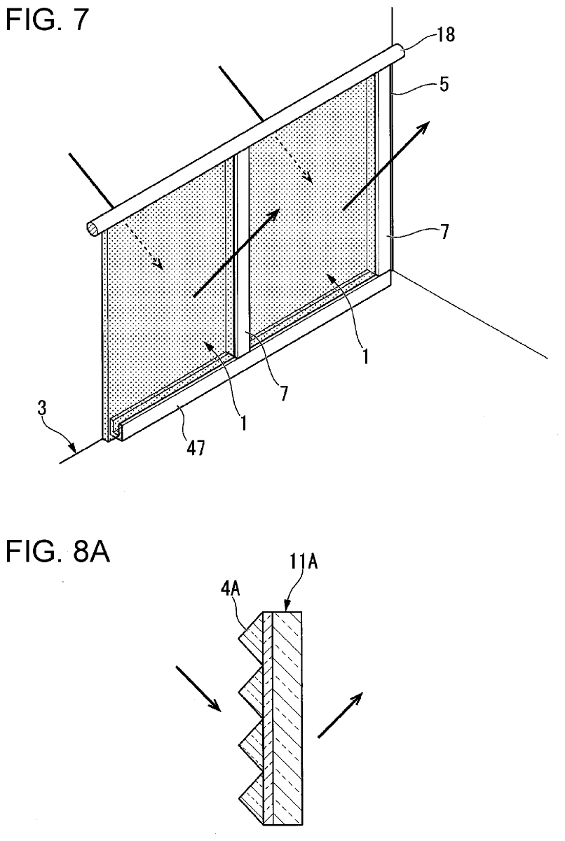

FIG. 7 illustrates a daylighting state of the daylighting device 1 integrated with the fence 5.

As illustrated in FIG. 7, the daylighting device 1 according to the present embodiment may be, for example, integrated with the fence 5 using fastening members (support members) 47. Specifically, the fence 5 may have a daylighting function. For example, by fitting the daylighting device 1 into each space between the multiple fence posts 7, constituting the vertical lattice 6 of the fence 5, gaps that have been formed between the fence 5 and the daylighting device 1 are no longer formed, so that the light use efficiency can be enhanced. Moreover, the daylighting device 1 no longer protrudes toward the veranda 3, so that the veranda 3 can be used more widely and effectively.

Here, the daylighting device 1 of the integrated type may be removably installed for ease of maintenance or replacement.

Alternatively, the daylighting device 1 may include, for example, a light transmissive thermal insulation film (thermal insulator) for blocking radiant heat of natural light (sunlight), an IR reflection film for reflecting infrared light (IR), or a design sheet.

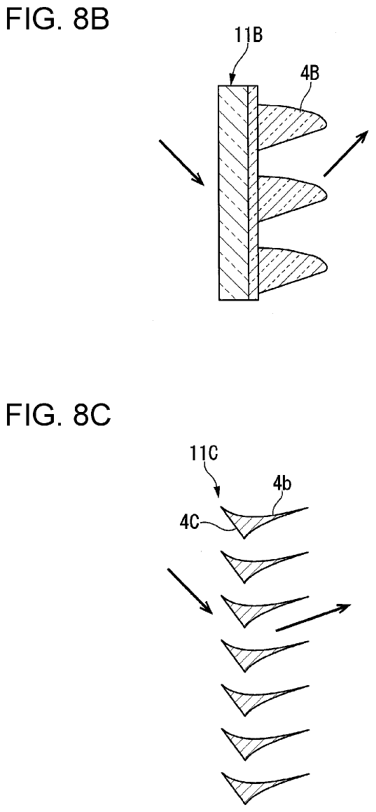

FIG. 8A to FIG. 8D illustrate modification examples of the daylighting device according to the first embodiment.

For example, as in a daylighting member 11A illustrated in FIG. 8A, a daylighting member may include daylighting portions 4A having a triangular cross section taken in the direction crossing the longitudinal direction.

Alternatively, as in a daylighting member 11B illustrated in FIG. 8B, a daylighting member may include daylighting portions 4B having a partially curved cross section taken in the direction crossing the longitudinal direction.

Still alternatively, as in a daylighting member 11C illustrated in FIG. 8C, a daylighting member may simply include daylighting portions 4C having a cross section of a substantially triangular prism, taken in the direction crossing the longitudinal direction. The daylighting portions 4C are fabricated by being cut out from an aluminum ingot using, for example, a milling machine.

The daylighting portions 4C each have a reflection surface 4b, which reflects light that is incident on the daylighting portion 4C.

In the present embodiment, the case where a light diffusion control film having a structure including projections and depressions of the order of micrometers is used as the anisotropic light diffusion film 16 has been described. However, besides the above example, as illustrated in FIG. 8D, for example, a lenticular-lens-type diffuser panel 17 may be included instead of the anisotropic light diffusion film 16. The diffuser panel 17 includes, for example, multiple lenticular lenses 19 and a support plate 8, which supports the multiple lenticular lenses 19. A surface 8a of the support plate 8 opposite to the surface on which the lenticular lenses 19 are disposed is bonded to the second surface 13b of the first base member 13 of a daylighting member 11D.

### Second Embodiment

A daylighting device 20 according to a second embodiment of the present invention will now be described.

The basic structure of the daylighting device 20 according to the present embodiment below is substantially the same as that of the first embodiment, but differs from that of the first embodiment in that it includes a transparent protective cover 23. Thus, the portion that differs from the corresponding portion in the first embodiment will be described in detail, and the common portions are not described, below. In the drawings used for the description, components the same as those in FIG. 1 to FIG. 8D are denoted with the same reference signs.

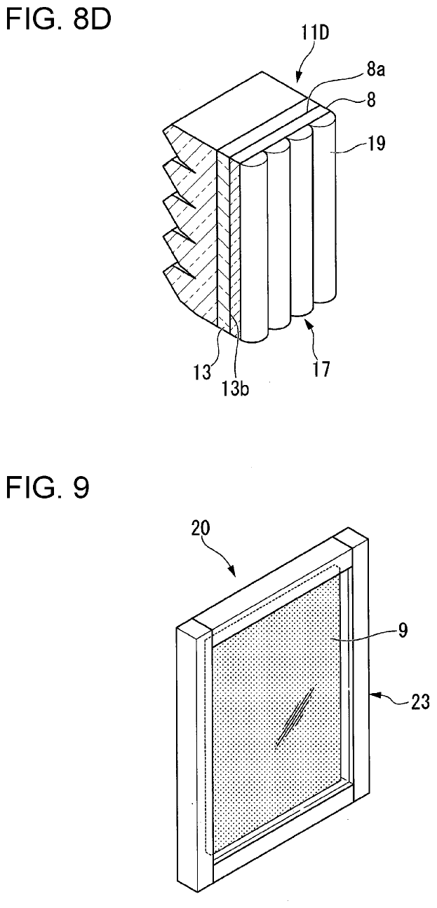

FIG. 9 is a perspective view of the entire structure of a daylighting device according to the second embodiment.

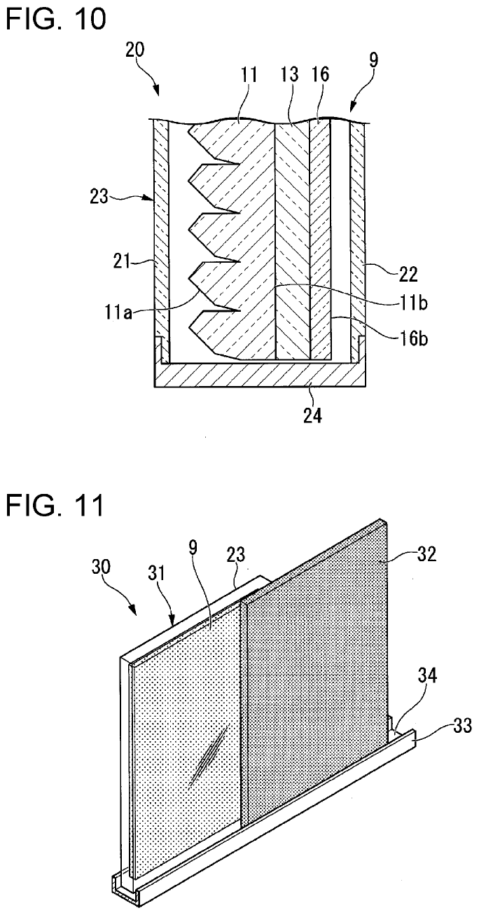

FIG. 10 is a cross-sectional view partially illustrating related components of the daylighting device according to the second embodiment.

As illustrated in FIG. 9, the daylighting device 20 according to the present embodiment includes the above-described daylighting structure 9 and a transparent protective cover 23, which covers the surroundings of the daylighting structure 9.

As illustrated in FIG. 10, the daylighting structure 9 includes a daylighting member 11, a first base member 13, and an anisotropic light diffusion film 16, described in the above embodiment.

The transparent protective cover 23 includes a first translucent protective member (translucent protective member) 21, a second translucent protective member (translucent protective member) 22, and a frame 24.

The first translucent protective member 21 and the second translucent protective member 22 are formed from transparent flat plate members, rectangular in a plan view and having substantially the same size. The first translucent protective member 21 is disposed over a fine structure surface 11a of the daylighting member 11 of the daylighting structure 9 to cover substantially the entirety of the fine structure surface 11a. The second translucent protective member 22 is disposed over a back surface 11b of the daylighting member 11, opposite to the fine structure surface 11a, to cover substantially the entirety of the anisotropic light diffusion film 16.

The frame 24 has a rectangular frame shape in a plan view, and holds the surroundings of the daylighting structure 9, and the first translucent protective member 21 and the second translucent protective member 22, disposed opposite to each other with the daylighting structure 9 interposed therebetween.

Examples of the material include resin, such as polycarbonate or acryl, and glass. The first translucent protective member 21 and the second translucent protective member 22 desirably have light resistance and ultraviolet resistance.

Besides the above structure, the transparent protective cover 23 may have any structure as long as flat portions opposing the light incident surface and the light emerging surface of the daylighting structure 9 are transparent.

For example, at least part of the first translucent protective member 21, the second translucent protective member 22, and the frame 24 may be integrated together.

For example, instead of the above-described flat plate members, a pair of translucent protective films may be used to be bonded to the fine structure surface 11a of the daylighting member 11 and a light emerging surface 16b of the anisotropic light diffusion film 16.

When the daylighting structure 9 according to the present embodiment is used outside as it is, dirt or dust may adhere to, for example, the fine structures of the daylighting structure 9 and reduce or diffuse emerging light, so that a sufficient daylighting effect is hindered from being obtained.

To address this, the daylighting structure 9 is covered with the transparent protective cover 23, so that dirt or dust in the air can be prevented from adhering to the gap portions 15 or the surface of the multiple daylighting portions 4 of the fine structure surface 11a of the daylighting member 11. Besides, dirt or dust can be prevented from adhering to the surface of the structure including projections and depressions of the anisotropic light diffusion film 16.

The structure according to the present embodiment can prevent reduction or diffusion of emerging light due to adhesion of dirt or dust, and thus can ensure a sufficiently large amount of emerging light. Since the daylighting device 20 is used outside, the daylighting structure 9 covered with the transparent protective cover 23 can be prevented from being degraded for the long term.

### Third Embodiment

A daylighting device according to a third embodiment of the present invention will now be described.

The basic structure of a daylighting device 30 according to the present embodiment below is substantially the same as that of the first embodiment, but differs from that of the first embodiment in that it also includes a light-shielding plate (light-shielding member) 32. Thus, the portion that differs from the corresponding portion in the first embodiment will be described in detail, and the common portions are not described, below. In the drawings used for the description, components the same as those in FIG. 1 to FIG. 8D are denoted with the same reference signs.

FIG. 11 illustrates a schematic structure of the daylighting device 30 according to the third embodiment.

The daylighting device 30 according to the present embodiment includes a daylighting unit 31, which includes a daylighting structure 9 and a transparent protective cover 23, a light-shielding plate (light-shielding member) 32, and a guide rail (guide member) 33.

The daylighting structure 9 and the transparent protective cover 23, which constitute the daylighting unit 31, have the same structures as those of the second embodiment, and are not described, here.

The light-shielding plate 32 is disposed over the light emerging side of the daylighting unit 31. The light-shielding plate 32 has a size large enough to block substantially the entirety of emerging light emerging from the daylighting unit 31, and is capable of unidirectionally reciprocating along the guide rail 33.

The guide rail 33 is disposed on the floor surface of the veranda 3 on the inner side of the fence 5 to be parallel to the fence 5, and holds lower ends of the daylighting unit 31 and the light-shielding plate 32 in a guide groove 34 extending in the longitudinal direction. The length of the guide rail 33 can be appropriately changed in design in accordance with, for example, the size of the daylighting unit 31 or the slidable range of the light-shielding plate 32.

In the present embodiment, the guide rail 33 is disposed on the inner side of the fence 5. Instead, the guide rail 33 may be disposed on the outer side of the fence 5, and the light-shielding plate 32 may be disposed over the light incident side of the daylighting unit 31. Alternatively, another guide rail opposing the guide rail 33 that supports the lower end of the daylighting unit 31 may be disposed at the upper end of the daylighting unit 31 to hold the daylighting unit 31 therebetween from the upper and lower sides while allowing the daylighting unit 31 to slide. This structure enables stable installation of the daylighting unit 31 and allows the daylighting unit 31 to move more smoothly.

In the present embodiment, the daylighting unit 31 and the light-shielding plate 32 are both inserted and held in the guide groove 34. Instead, only the light-shielding plate 32 may be inserted in the guide groove 34.

In the present embodiment, a plate member made of polycarbonate is used as the light-shielding plate 32. The light-shielding plate 32 is not limited to this, and any opaque material such as metal may be used.

Examples of the opaque material include aluminum foil, and a film (base member) having a predetermined shape and formed by adding a pigment to an optically transparent resin such as triacetyl cellulose (TAC), polyethylene terephthalate (PET), cycloolefin polymer (COP), polycarbonate (PC), polyethylene naphthalate (PEN), polyether sulphone (PES), and polyimide (PI).

Here, a reflective plate that reflects light may be used as a light-shielding member according to an aspect of the present invention.

In the present embodiment, the light-shielding plate 32 is disposed over the light emerging side of the daylighting unit 31, but may be disposed over the light incident side of the daylighting unit 31.

In the daylighting device 30 according to the present embodiment, the light-shielding plate 32 is slid between an inroad position, in which it overlaps the daylighting unit 31 in the direction in which light is transmitted (in which light passes), and a retraction position, in which it does not overlap the daylighting unit 31, to appropriately switch between a daylighting state and a light-shielding state. The light-shielding plate 32 can be also stopped at any position between the inroad position and the retraction position. Thus, the daylighting degree and the light-shielding degree can be appropriately adjusted. By adjusting the amount of light emitted to the space K under the eaves 2 in the veranda 3 or the balcony using the daylighting device 30 according to the present embodiment, the glare that a person in the room feels can be reduced.

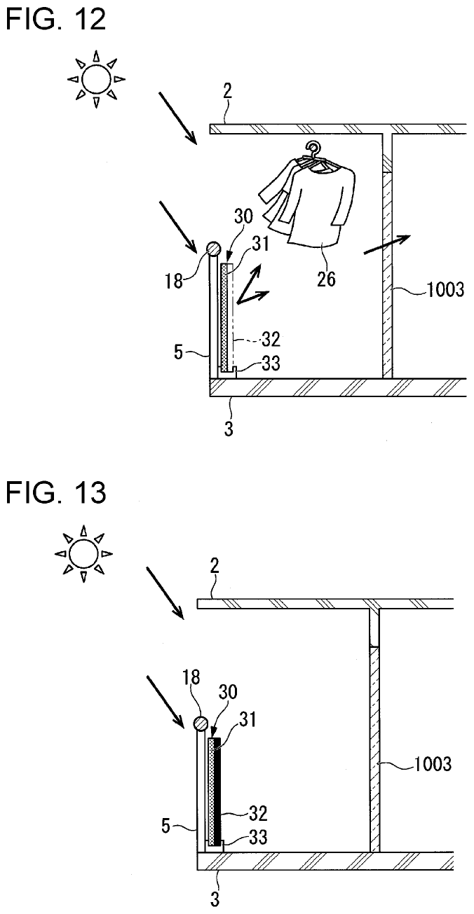

FIG. 12 illustrates the operation and effects (daylighting state) of the daylighting device 30 according to the third embodiment.

As illustrated in FIG. 12, the light-shielding plate 32 may be in the retraction position while, for example, the washing 26 is hung in the veranda 3 to allow the daylighting unit 31 to fully radiate light toward the washing 26. This structure can make the washing 26 in the same state as when the washing 26 is exposed to direct sunlight, and accelerate drying of the washing 26.

FIG. 13 illustrates the operation and effects (light-shielding state) of the daylighting device 30 according to the third embodiment.

As illustrated in FIG. 13, when light is not needed to be captured in the veranda 3, such as when the washing is not hung in the veranda 3, the light-shielding plate 32 may be moved to the inroad position, in which it overlaps the daylighting unit 31 in the direction in which light is transmitted, to reduce the glare that a person in the room feels.

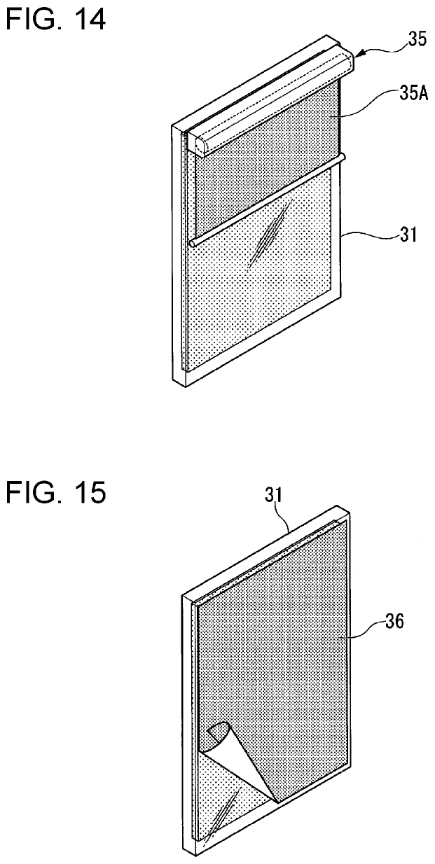

FIG. 14 illustrates a modification example (roll screen type) daylighting device according to the third embodiment.

As illustrated in FIG. 14, a light-shielding roll screen 35 may be disposed on either one of the light incident side and the light emerging side of the daylighting unit 31. The roll screen 35 includes a light-shielding screen 35A, which blocks light emerging from the daylighting unit 31, and is disposed at, for example, the upper end of the daylighting unit 31. The light-shielding screen 35A, which can be vertically wound, can save the space. Here, to prevent the light-shielding screen 35A from being moved up by the wind, for example, a frame is preferably disposed to restrict the lower end or both sides of the light-shielding screen 35A relative to the daylighting unit 31.

Instead of the above-described roll screen 35, a vertically foldable blind may be used as a light-shielding member according to an aspect of the present invention.

FIG. 15 illustrates a modification example (bonded type) of the daylighting device according to the third embodiment.

As illustrated in FIG. 15, a light-shielding sheet member 36 may be bonded to either one of the light incident side and the light emerging side of the daylighting unit 31. The sheet member 36 is removably bonded to the daylighting unit 31, and appropriately selectable between the light-shielding state and the daylighting state depending on the season or other factors. The sheet member 36 having, for example, adhesive power restorable by washing with water is repeatedly reusable for a long term and can reduce the costs.

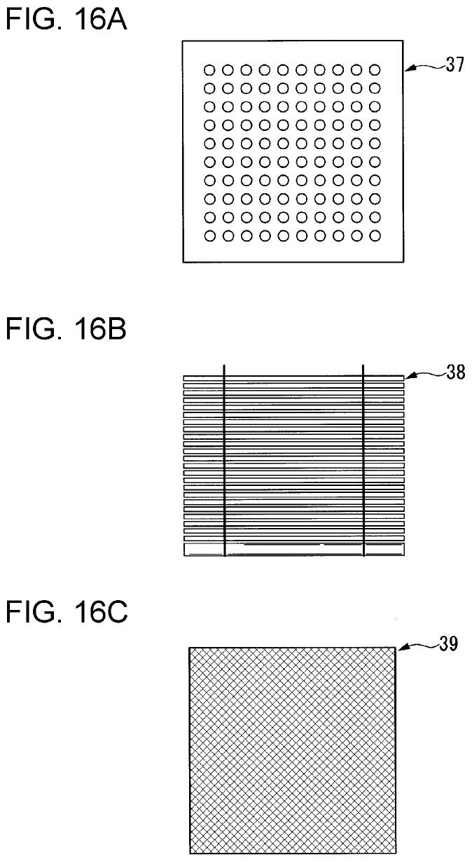

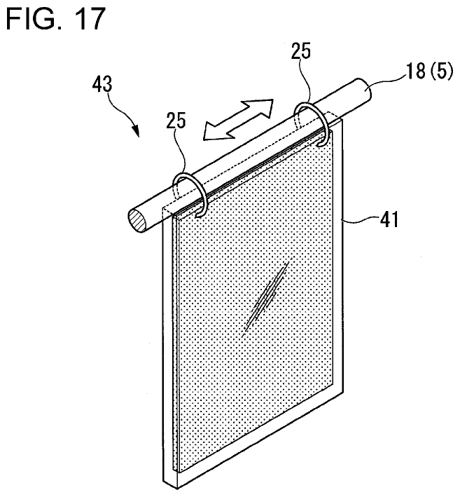

FIG. 16A to FIG. 16C illustrate examples of a light-attenuating member according to the third embodiment.

In the present embodiment, the structure including a light-shielding member that blocks light emerging from the daylighting unit 31 has been described. The structure is not limited to this, and may include a light-attenuating member that attenuates emerging light by partially blocking light. Examples of the light-attenuating member include a punched metal (light-attenuating member) 37, which is a metal plate having a large number of holes as illustrated in FIG. 16A, a reed screen (light-attenuating member) 38 as illustrated in FIG. 16B, and a net (light-attenuating member) 39 as illustrated in FIG. 16C.

### Fourth Embodiment

A daylighting device 43 according to a fourth embodiment of the present invention will now be described.

The basic structure of the daylighting device 43 according to the present embodiment below is substantially the same as that of the first embodiment, but differs from that of the first embodiment in that it includes a moving function. Thus, the portion that differs from the corresponding portion in the first embodiment will be described in detail, and the common portions are not described, below. In the drawings used for the description, components the same as those in FIG. 1 to FIG. 8D are denoted with the same reference signs.

### EXAMPLE 1

FIG. 17 illustrates a schematic structure of a daylighting device 43 of Example 1 of a fourth embodiment.

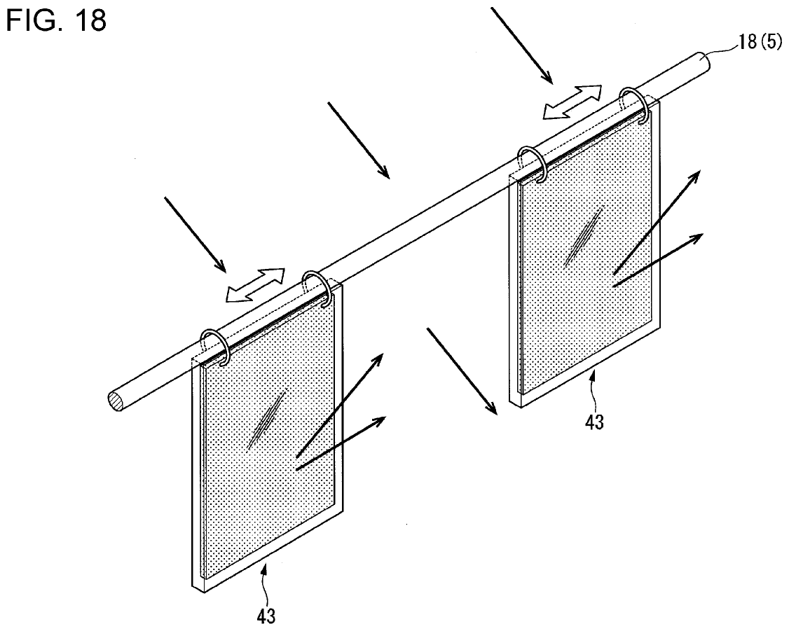

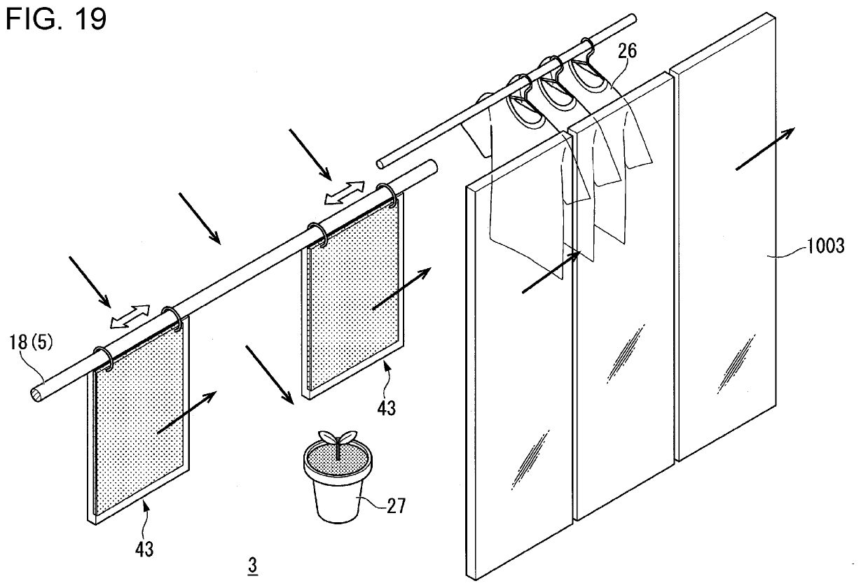

FIG. 18 and FIG. 19 illustrate the operation and effects of the daylighting device 43 of Example 1 according to the fourth embodiment.

The daylighting device 43 illustrated in FIG. 17 includes a pair of ring-shaped attachments (support members) 25. A daylighting unit 41 is attached to the handrail portion 18 of the veranda 3 or a guide pole using these attachments 25. Any devices can be used as the attachments 25 as long as they can attach the daylighting unit 41 to the handrail portion 18 while allowing the daylighting unit 41 to move relative to the handrail portion 18. For example, the attachments 25 may be hooks, wires, or strings.

By suspending the daylighting unit 41 from the handrail portion 18 using the attachments 25, the daylighting device 43 is made slidable along the handrail portion 18 (FIG. 18). As illustrated in FIG. 18, multiple daylighting devices 43 may be attached to the handrail portion 18 (or guide pole) of the fence 5 of the veranda 3, so that the daylighting devices 43 may be moved to appropriate positions. For example, as illustrated in FIG. 19, a daylighting device 43 may be disposed at a position at which it can effectively transmit light to the washing 26 to accelerate drying of the washing 26. Concurrently, when a planter 27 or the like is disposed on the veranda 3 to grow plants or vegetables, the daylighting devices 43 may be slid to form a gap therebetween to allow the planter 27 to be irradiated with direct sunlight. In such a structure in which multiple daylighting devices 43 are disposed to be movable relative to the handrail portion 18, the daylighting devices 43 can be moved to appropriate positions of the veranda 3 to enhance the convenience.

### Example 2

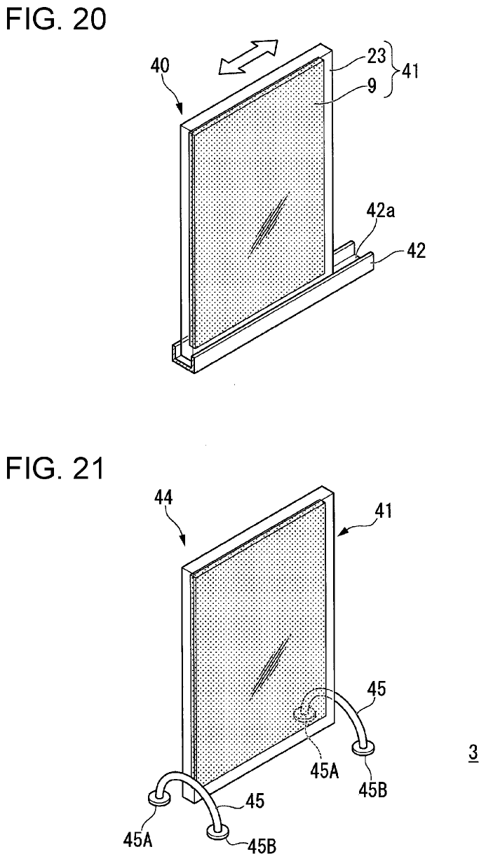

FIG. 20 illustrates a schematic structure of a daylighting device 40 of Example 2 according to the fourth embodiment.

As illustrated in FIG. 20, the daylighting device 40 of Example 2 includes a daylighting unit 41, which includes a daylighting structure 9 and a transparent protective cover 23, and a guide rail 42, which allows the daylighting unit 41 to unidirectionally reciprocate. The present embodiment may also include the above-described light-shielding member or light-attenuating member for the daylighting unit 41.

The daylighting structure 9 and the transparent protective cover 23 constituting the daylighting unit 41 have substantially the same structure as those according to the above-described second embodiment, and thus are not described here.

The daylighting unit 41 has its lower end inserted and held in a guide groove 42a of the guide rail 42, and unidirectionally reciprocates along the guide groove 42a.

### Example 3

FIG. 21 is a schematic structure illustrates a daylighting device 44 of Example 3 according to the fourth embodiment.

As illustrated in FIG. 21, the daylighting device 44 of Example 3 differs from the above structure in that it stands on its own, instead of being attached to the fence 5. The daylighting device 44 can be mounted on the floor surface of the veranda 3 using a pair of support legs (support members) 45. The support legs 45 are attached at lower portions of the daylighting unit 41, and may have, for example, a function of adjusting the height of the daylighting unit 41.

As illustrated in, for example, FIG. 21, each support leg 45 includes a first support portion 45A and a second support portion 45B, which respectively protrude to the front and the back (from the light incident surface and the light emerging surface) of the daylighting unit 41. Thus, the daylighting unit 41 is supported at four points, and thus more effectively prevented from falling.

### Fifth Embodiment

Daylighting devices 50A and 50B according to a fifth embodiment of the present invention will now be described.

The basic structures of the daylighting devices 50A and 50B according to the present embodiment below are substantially the same as that of the first embodiment, but differ from that of the first embodiment in that the daylighting area in the width direction is appropriately changeable. Thus, the portions that differ from the corresponding portion in the first embodiment will be described in detail, and the common portions are not described, below. In the drawings used for the description, components the same as those in FIG. 1 to FIG. 8D are denoted with the same reference signs.

### EXAMPLE 1

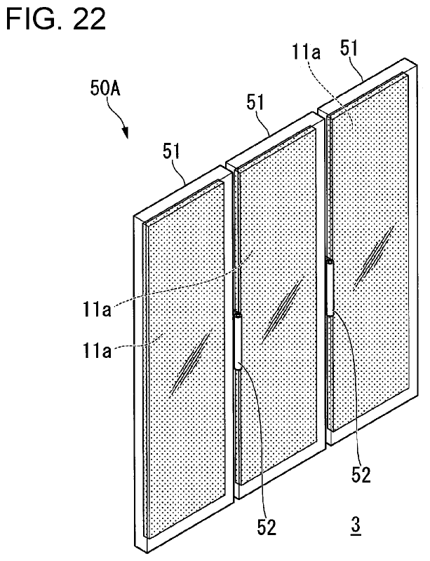

FIG. 22 illustrates a schematic structure of the daylighting device 50A of Example 1 according to the fifth embodiment. FIG. 24 illustrates the operation and effects of the daylighting device 50A of Example 1.

As illustrated in FIG. 22, the daylighting device 50A of Example 1 includes multiple daylighting units 51, coupling members 52, each of which couples the multiple daylighting units 51 together, and a rail, which extends along the fence 5 and is not illustrated. The daylighting device 50A allows the multiple daylighting units 51 to move along the rail so that they are positioned at appropriate positions. Each daylighting unit 51 is coupled with another while having the fine structure surface 11a oriented to the outer side of the veranda 3.

In the present embodiment, the multiple daylighting units 51 are coupled with the coupling members 52, so that the number of the daylighting unit 51 used can be adjusted. In other words, the daylighting area of the daylighting device 50A can be appropriately changed. When some of the daylighting units 51 are left unused, these daylighting units 51 can be folded up and stored. In the present embodiment, a hinge is used as an example of each coupling member 52, so that the number of the daylighting units 51 can be easily increased or reduced later.

Thus, the daylighting area of the daylighting device 50A can be appropriately changed.

### EXAMPLE 2

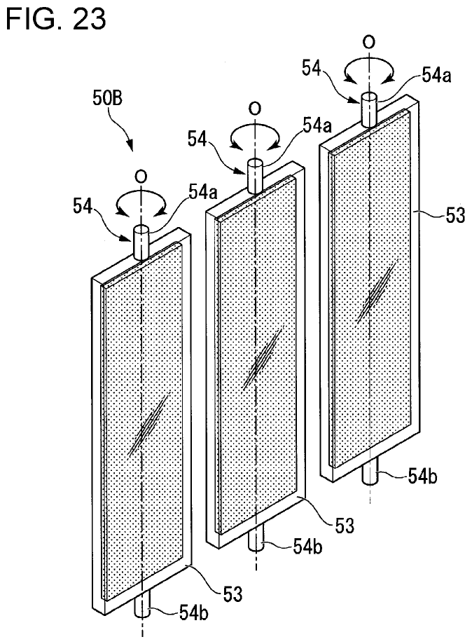

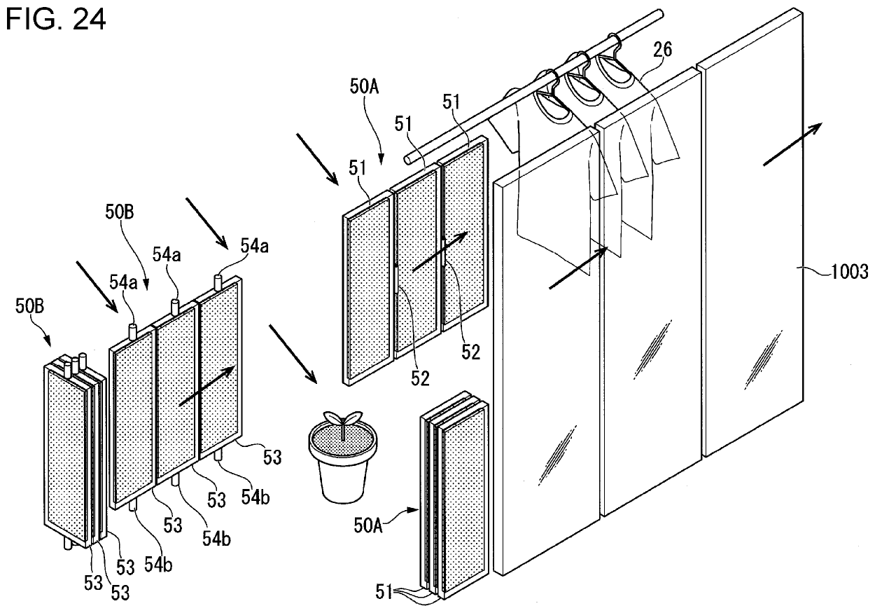

FIG. 23 illustrates a schematic structure of the daylighting device 50B of Example 2 according to the fifth embodiment. FIG. 24 illustrates the operation and effects of the daylighting device 50B of Example 2.

As illustrated in FIG. 23, the daylighting device 50B of Example 2 includes multiple daylighting units 53, movable portions 54 disposed for the respective daylighting units 53, and a rail, which extends along the fence 5 and is not illustrated. The daylighting device 50B allows the multiple daylighting units 53 to move along the rail so that they can be positioned at appropriate positions.

As illustrated in FIG. 23, each movable portion 54 is formed from a cylindrical member, and includes a first movable portion 54a, disposed at one end (upper end) of the strip-shaped daylighting unit 53 in the longitudinal direction, and a second movable portion 54b, disposed at another end (lower end) of the daylighting unit 53 in the longitudinal direction. The movable portion 54 is disposed on the center line extending in the longitudinal direction of the daylighting unit 53. Each movable portion 54 has a rotation axis O, about which the width of the daylighting unit 53 turns. Thus, the daylighting unit 53 turns (moves) about the rotation axis O of the movable portion 54.

In the present embodiment, the movable portion 54 of each daylighting unit 53 moves so that the daylighting unit 53 is directed to the sun following the movement of the sun. Thus, regardless of a change of the orientation of the sun, sunlight that is incident on each daylighting unit 53 can be efficiently applied to the space K in the veranda 3 shaded by the eaves 2. Thus, sunlight is also usable in the space that does not receive sunlight even in the daytime due to the structure of the building.

The daylighting device 50B according to the present embodiment has a structure in which the multiple daylighting units 53 divide the daylighting area. Thus, a user can appropriately adjust the daylighting area in the direction in which the fence 5 extends, or, in the lateral direction of the veranda 3 when viewed from the room. When some of the daylighting units 53 are left unused, the movable portions 54 can be turned and piled up to be stored.

### Sixth Embodiment

A daylighting blind 60 according to a sixth embodiment of the present invention will now be described.

The basic structure of the daylighting blind 60 according to the present embodiment below is substantially the same as that of the first embodiment, but differs from that of the first embodiment in that the daylighting area in the height direction is appropriately changeable. Thus, the portion that differs from the corresponding portion in the first embodiment will be described in detail, and the common portions are not described, below. In the drawings used for the description, components the same as those in FIG. 1 to FIG. 8D are denoted with the same reference signs.

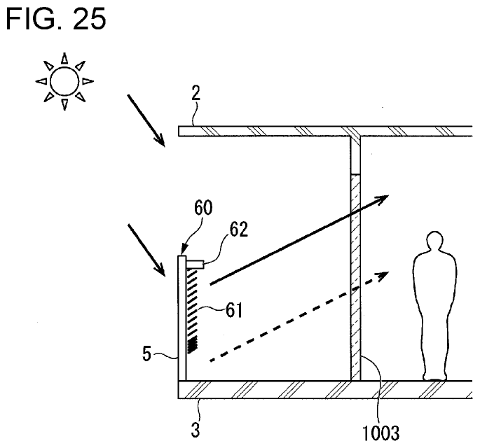

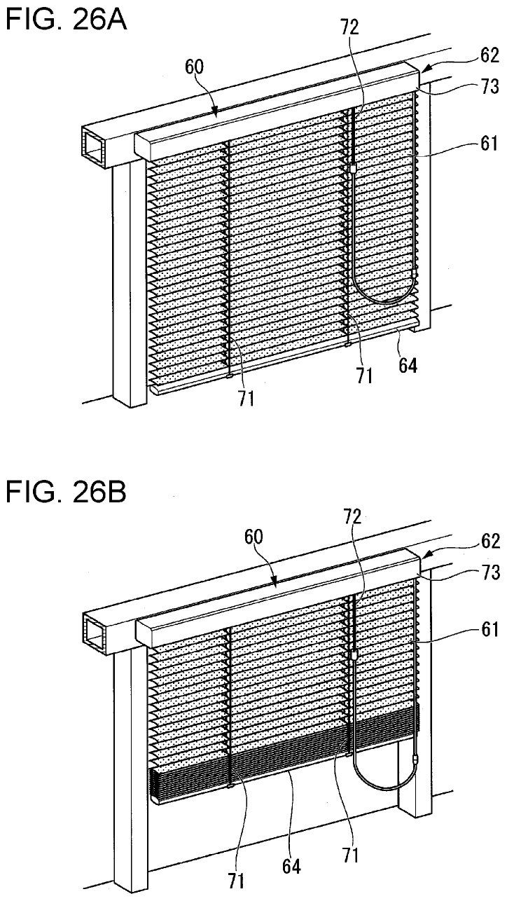

FIG. 25 illustrates the installation state of the daylighting blind 60 according to the sixth embodiment. FIGS. 26A and 26B illustrate the open and closed states of the daylighting blind 60 according to the sixth embodiment.

As illustrated in FIG. 25, the daylighting blind (daylighting member) 60 according to the present embodiment mainly includes multiple daylighting slats (slats) 61, arranged parallel to each other in the horizontal direction, and a support mechanism 62, which supports the multiple daylighting slats 61 by suspending the daylighting slats 61 in the vertical direction. The daylighting blind 60 is installed on the inner side (or outer side) of the fence 5 of the veranda 3. In the daylighting blind 60, the multiple daylighting slats 61 are supported while being allowed to be raised or lowered and while being capable of tilting.

The daylighting slats 61 are each formed by, for example, bonding the above-described daylighting film 14 on one surface of the slat body (not illustrated) extending on one direction.

The support mechanism 62 includes a pair of daylighting-slat ladder cords 71, disposed for the daylighting slats 61, a fastening box 73, which supports upper ends of the pair of ladder cords 71, and a lift bar 64, attached to lower ends of the pair of ladder cords 71. The support mechanism 62 also includes a lift cord 72, parallel to the pair of ladder cords 71. When a user operates the lift cord 72, the user can expand or contract the daylighting slats 61, as illustrated in FIG. 26A and FIG. 26B.

In the daylighting blind 60 according to the present embodiment, the daylighting area in the height direction can be appropriately changed. As illustrated in FIG. 25, the daylighting blind 60 changes the direction of incident light to the upper direction. Thus, light incident on a lower daylighting slat 61 is transmitted to a further position than light incident on an upper daylighting blind 60. The daylighting slats 61 can be used differently for different purposes; for example, when a person in the room feels the glare, the daylighting slats 61 on the lower side are folded into a non-daylighting state and only the daylighting slats 61 on the upper side are used for daylighting.

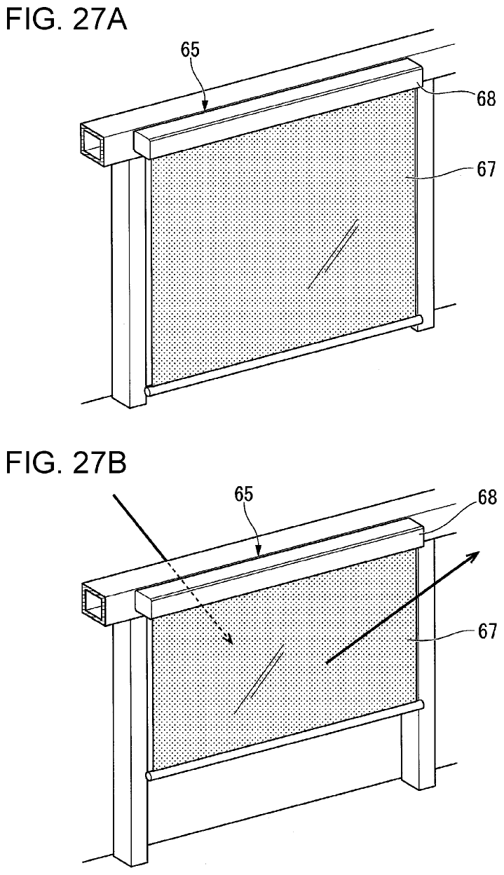

FIG. 27A and FIG. 27B illustrate a daylighting roll screen of a modification example of the daylighting device according to the sixth embodiment.

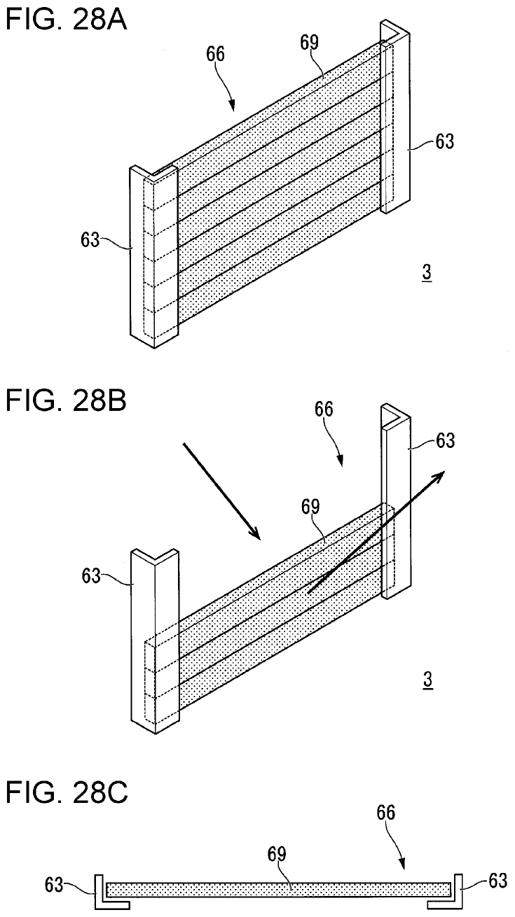

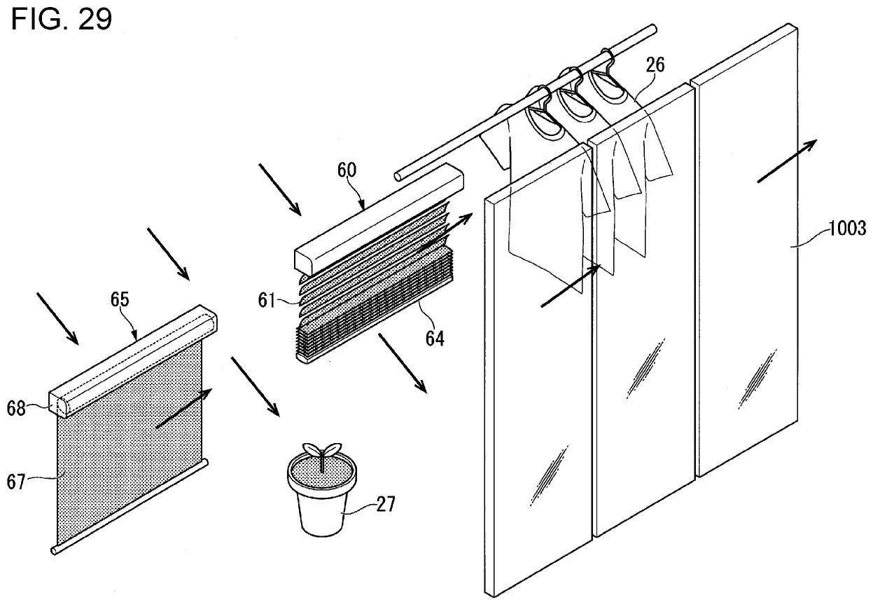

Examples of the modification example of the present embodiment include a hoisting daylighting roll screen 65, as illustrated in FIG. 27A and FIG. 27B, and a stack-type daylighting panel 66, as illustrated in FIG. 28A to FIG. 28C.

The daylighting roll screen (daylighting member) 65, illustrated in FIG. 27A and FIG. 27B, includes a daylighting screen (daylighting member) 67 and a winding mechanism 68, which supports the daylighting screen 67 while appropriately winding the daylighting screen 67. The daylighting screen 67 is formed by, for example, bonding the above-described daylighting film 14 onto a surface of a transparent screen body. When the winding mechanism 68 winds or unwinds the daylighting screen 67, the daylighting area of the daylighting screen 67 can be changed as intended in the height direction.

FIG. 28A to FIG. 28C illustrate a daylighting panel, which is a modification example of the daylighting device according to the sixth embodiment.

A daylighting panel (daylighting member) 66 illustrated in FIG. 28A, FIG. 28B, and FIG. 28C includes, for example, a pair of panel frames 63, which stand erect on the floor surface of the veranda 3, and multiple daylighting panel plates (daylighting member) 69, inserted between these panel frames 63. The daylighting panel plates 69 each include, for example, the above-described daylighting member 11 or the daylighting structure 9. By stacking the multiple daylighting panel plates 69 from below between the panel frames 63, the daylighting area in the height direction can be appropriately changed.

FIG. 29 illustrates the operation and effects of the daylighting device according to the sixth embodiment.

As illustrated in FIG. 29, the daylighting blind 60 or the daylighting roll screen 65 is capable of appropriately adjusting the daylighting area in the height direction. Thus, for example, by contracting the lower side of the daylighting blind 60 or the daylighting roll screen 65, a potted plant or the like placed on the floor surface of the veranda 3 can be irradiated with direct sunlight. Alternatively, by using the upper side of the daylighting blind 60 or the daylighting roll screen 65, sunlight can be transmitted to the washing 26 hanging from the ceiling to accelerate drying.

In this manner, the daylighting state and the non-daylighting state can be easily switched therebetween depending on the purposes, so that a preferably daylighting space can be provided.

Thus far, preferred embodiments of the present invention have been described with reference to the appended drawings, but naturally, the present invention is not limited to these embodiments. It is obvious for persons having ordinary skill in the art that different modification examples or amendment examples are conceivable within the scope of the technical idea described in the scope of claims. It is naturally understood that these examples also belong to the technical scope of the present invention.

### INDUSTRIAL APPLICABILITY

An aspect of the present invention is applicable to a daylighting device that needs to ensure solar radiation to a space shaded by an eaves without degrading the view from a room.

### REFERENCE SIGNS LIST

1, 20, 30, 40, 43, 44, 50A, 50B daylighting device

2 eaves

4, 4A, 4B, 4C daylighting portion

11, 11A, 11B, 11C, 11D daylighting member

11a fine structure surface

11b back surface

12 support member

13 first base member

13a first surface

15 gap portion

16b light emerging surface

18 handrail portion

21 first translucent protective member (translucent protective member)

22 second translucent protective member (translucent protective member)

25 attachment (support member)

32 light-shielding plate (light-shielding member)

33 guide rail (guide member)

37 punched metal (light-attenuating member)

38 reed screen (light-attenuating member)

39 net (light-attenuating member)

45 support leg (support member)

47 fastening member (support member)

52 coupling member

60 daylighting blind (daylighting device)

61 daylighting slat (slat)

62 support mechanism

63 panel frame

65 daylighting roll screen (daylighting device)

66 daylighting panel (daylighting device)

67 daylighting screen (daylighting device)

68 winding mechanism

69 daylighting panel plate (daylighting device)

73 fastening box

1003 window

K space

O rotation axis

1. A daylighting device for a building construction including an eaves that blocks solar radiation on an outer side of a window, comprising:
a daylighting member including
a first base member that is light transmissive,
a plurality of daylighting portions that are light transmissive and disposed on a first surface of the first base member, and
a gap portion disposed between the plurality of daylighting portions; and
a support member that supports the daylighting member,
wherein the daylighting device changes an orientation of light incident thereon and causes the light to emit to a space shaded by the eaves.

2. The daylighting device according to claim 1, further comprising:
a translucent protective member that covers, of a fine structure surface of the daylighting member and a back surface opposite to the fine structure surface, at least the fine structure surface, the plurality of multiple daylighting portions being disposed on the fine structure surface.

3. The daylighting device according to claim 1, further comprising:
a light-shielding member that blocks light incident on the daylighting member or a light-attenuating member that attenuates the light, the member being disposed on either one of a light incident side and a light emerging side of the daylighting member.

4. The daylighting device according to claim 1,
wherein the support member is an attachment with which the daylighting member is attached to the building construction.

5. The daylighting device according to claim 1, further comprising:
a guide member that moves the daylighting member in one direction.

6. The daylighting device according to claim 1,
wherein the support member is a support leg that allows the daylighting member to stand independently.

7. The daylighting device according to claim 1,
wherein the support member includes a rotation axis in a vertical direction.

8. The daylighting device according to claim 1,
wherein a plurality of the daylighting members are coupled to each other using a coupling member.

9. A daylighting system, comprising:
a plurality of slats; and
a support mechanism that couples the plurality of slats while having a longitudinal direction of the plurality of slats oriented in a horizontal direction, and that supports the plurality of slats by allowing the slats to hang therefrom in a vertical direction,
wherein the daylighting device according to claim 1 is employed as each of the slats.

10. A daylighting system, comprising:
a daylighting screen; and
a winding mechanism capable of winding the daylighting screen,
wherein the daylighting device according to claim 1 is employed as the daylighting screen.

11. A daylighting system, comprising:
a plurality of daylighting panels; and
a panel frame that supports a stack of the plurality of daylighting panels,
wherein the daylighting device according to claim 1 is employed as each of the plurality of daylighting panels.
